(19) United States
(12) Patent Application Publication
(10) Pub. No.: US 2014/0238619 A1
(43) Pub. Date: Aug. 28, 2014

(54) Method And Apparatus For Mounting A Tire

(71) Applicants: Neel K. Mani, Stow, OH (US); John L. Turner, Tucson, AZ (US)

(72) Inventors: Neel K. Mani, Stow, OH (US); John L. Turner, Tucson, AZ (US)

(21) Appl. No.: 14/348,203

(22) PCT Filed: Sep. 11, 2012
(86) PCT No.: PCT/US12/54625

§ 371 Date: Mar. 28, 2014

Related U.S. Application Data
(60) Provisional application No. 61/543,827, filed on Oct. 6, 2011.

(51) Int. Cl. B60C 25/05

(52) U.S. Cl. CPC B60C 25/0593; B60C 25/0545
USPC 157/1.24; 29/894.31

(57) ABSTRACT

A tire mounting device is configured to mount a tire to a wheel having a wheel well. The tire mounting device includes a plurality of tire engaging members including a first tire engaging member, a second tire engaging member, and a third tire engaging member. Each of the plurality of tire engaging members is configured to move into and out of engagement with a sidewall of the tire. The tire mounting device further includes a tire rotating device configured to rotate the tire about an axis. At least one member rotating apparatus is configured to rotate the second tire engaging member and the third tire engaging member about the axis.

### FIELD OF INVENTION

The present disclosure relates to the field of tire mounting. More particularly, the present disclosure relates to an apparatus and method for mounting a tire to a wheel.

### BACKGROUND

A pneumatic tire has bead portions that engage a well of a wheel. Tires may be manually mounted to wheels, or the process may be automated. In prior devices, a wheel may be placed on a conveyor, and a tire is supported on the wheel in a preliminarily assembled relationship. The wheel and tire are then moved to a mounting apparatus. The mounting apparatus spreads the bead of the tire and forces the tire over the wheel rim to locate the tire between the wheel rims so that the tire can be inflated.

### SUMMARY OF THE INVENTION

In one embodiment, an apparatus for mounting a tire to a wheel is disclosed. The apparatus includes a tire rotating device configured to rotate a tire about an axis of rotation. The apparatus further includes a plurality of tire engaging members, including at least a first tire engaging member and a second tire engaging member. Each tire engaging member is configured to engage a sidewall of the tire. The apparatus further includes a plurality of arms, including at least a first arm connected to the first tire engaging member and a second arm connected to the second tire engaging member. Each of the plurality of arms is configured to move a respective connected tire engaging member into engagement with the sidewall of the tire, thereby moving a proximal section of a bead of the tire into a well of the wheel. Each of the plurality of arms is further configured to move the respective connected tire engaging members out of engagement with the sidewall of the tire. An arm rotating device is configured to rotate the second arm about the axis of rotation.

In another embodiment, a tire mounting device is configured to mount a tire to a wheel having a wheel well. The tire mounting device includes a plurality of tire engaging members including a first tire engaging member, a second tire engaging member, and a third tire engaging member. Each of the plurality of tire engaging members is configured to move into and out of engagement with a sidewall of the tire. The tire mounting device further includes a tire rotating device configured to rotate the tire about an axis. At least one member rotating apparatus is configured to rotate the second tire engaging member and the third tire engaging member about the axis.

In yet another embodiment, a method of mounting a tire to a wheel is disclosed. The method includes providing a wheel, providing a tire, and rotating the tire about an axis of the tire at a first speed. The method further includes moving a first member into engagement with a sidewall of the tire, such that a proximal section of a bead of the tire is placed in a well of the wheel. A second member is moved into engagement with the sidewall of the tire, such that the section of the bead of the tire is retained in the well of the wheel.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a schematic drawing illustrating a side view of one embodiment of a tire mounting device in a first position;

FIG. 2 is a schematic drawing illustrating a top view of the tire mounting device of FIG. 1;

FIG. 3 is a schematic drawing illustrating a side view of the tire mounting device in a second position;

FIG. 4 is a schematic drawing illustrating a side view of the tire mounting device in a third position;

FIG. 5 is a schematic drawing illustrating a side view of the tire mounting device in a fourth position;

FIG. 6 is a schematic drawing illustrating a top view of the tire mounting device of FIG. 5;

FIG. 7 is a schematic drawing illustrating a side view of the tire mounting device in a fifth position;

FIG. 8 is a schematic drawing illustrating a side view of the tire mounting device in a sixth position;

FIG. 9 is a schematic drawing illustrating a top view of the tire mounting device of FIG. 8;

FIG. 10 is a schematic drawing illustrating a side view of the tire mounting device in a final position; and

FIG. 11 is a graph illustrating a deflection of a tire caused by tire engaging members of the tire mounting device during rotation of the tire.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” or “axially” refer to a direction that is parallel to the axis of rotation of a tire.

“Radial” or “radially” refer to a direction perpendicular to the axis of rotation of the tire.

Directions are also stated in this application with reference to the axis of rotation of the tire. The terms “inward” and “inwardly” refer to a general direction towards the rotational axis of the tire, whereas “outward” and “outwardly” refer to a general direction away from the rotational axis of the tire and towards the circumferential tread of the tire. Thus, when relative directional terms such as “inner” and “outer” are used in connection with an element, the “inner” element is spaced closer to the rotational axis of the tire than the “outer” element.

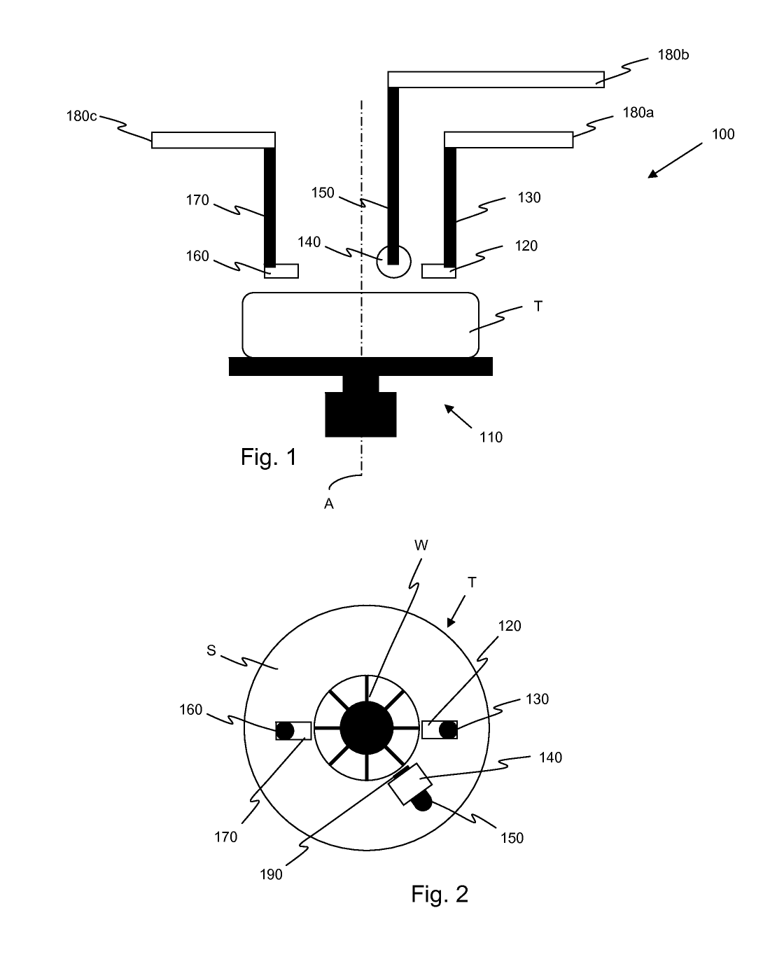

FIGS. 1 and 2 are schematic drawings of a side view and top view, respectively, of one embodiment of a tire mounting device 100 in a first position above a tire T. The tire mounting device 100 includes a tire rotating device 110 configured to rotate a tire about an axis of rotation A around a wheel W. In one embodiment, the wheel W and the tire T rotate together. In an alternative embodiment, the wheel is fixed in place.

In the illustrated embodiment, the tire T rests upon the tire rotating device 110, and is not otherwise secured until it is engaged by tire engaging member 120. In an alternative embodiment (not shown), the tire may be secured to the tire rotating device with a clamp or other fastener. In the illustrated embodiment, the tire rotating device 110 is a turntable, rotated by an electric motor. In alternative embodiments, a spindle, rollers, or other rotating devices may be employed instead of a turntable. Additionally, in alternative embodiments, the rotating device may be driven by pneumatics, hydraulics, or other rotary means.

FIG. 1 shows the tire T disposed on the tire rotating device 110 in a substantially horizontal position. In alternative embodiments (not shown), the tire T may be disposed vertically or at an acute angle. Such embodiments would require additional components to maintain the proper orientation of the tire.

The tire mounting device 100 further includes a plurality of tire engaging members, including at least a first tire engaging member 120 connected to a first arm 130, a second tire engaging member 140 connected to a second arm 150, and a third tire engaging member 160 connected to a third arm 170. Each tire engaging member 120, 140, 160 is positioned above a sidewall S of the tire T and is movable by its respective arm 130, 150, 170 to come into and out of engagement with the sidewall S. The arms 130, 150, 170 may be telescopic, or may be moved by a motor, a cam and follower, electronic controls, hydraulic controls, or other mechanical means.

In an alternative embodiment (not shown), the tire mounting device includes only two arms and two tire engaging members. In another alternative embodiment (not shown), the tire mounting device includes four or more arms and tire engaging members.

In the illustrated embodiment, the arms 130, 150, 170 are substantially orthogonal to the sidewall S and move the respective tire engaging members 120, 140, 160 in a substantially vertical direction to engage the sidewall S. In an alternative embodiment (not shown), one or more of the arms is disposed at an acute angle with respect to the sidewall S. In such an embodiment, each respective tire engaging member may be moved at an acute angle towards the sidewall.

As shown schematically in FIG. 1, the tire mounting device 100 further includes arm rotating devices 180a,b,c configured to rotate arms 130, 150, 170, respectively, about the axis of rotation A. In the illustrated embodiment, the arm rotating devices 180a,b,c are elongated members. In alternative embodiments, the arm rotating device may include a track that the arms follow, or each arm may be disposed on a rotating ring. However, it should be understood that any rotating device may be employed.

In the illustrated embodiment, the first tire engaging member 120 is a member that is rigidly connected to the first arm 130. Such a rigidly connected member may be referred to as a “shoe.” The third tire engaging member 160 is also a shoe.

The second tire engaging member 140 is a roller that rotates about a shaft 190 extending from the second arm 150. In the illustrated embodiment, the shaft 190 extends parallel to the sidewall S of the tire T in a radial direction of the tire T. In alternative embodiments (not shown), the shaft 190 may extend in any direction.

In the illustrated embodiment, the shaft 190 has a first end connected to the second arm 150 and a second end that is free. In an alternative embodiment, the second arm includes a first and second member. In such an embodiment, the first end of the shaft is connected to the first member of the arm and the second end of the shaft is connected to the second member of the arm.

In an alternative embodiment (not shown), two or more of the tire engaging members are rollers. In another alternative embodiment (not shown), all of the tire engaging members are shoes.

In FIGS. 1 and 2, the tire T, wheel W, and the tire mounting device 100 are in an initial position. In this initial position, the tire T is in contact with the wheel W, and the tire T and wheel W are substantially coaxial. A bottom bead of the tire T is seated in a bottom well of the wheel W, but a top bead of the tire T is not seated in a top well of the wheel W. Therefore, the tire T is not yet mounted to the wheel W.

In the initial position, the tire T and wheel W are disposed on the tire rotating device 110. Each of the tire engaging members 120, 140, and 160 is spaced vertically from the sidewall S of the tire T, and not in contact with the tire T. Alternatively, the first tire engaging member 120 may be placed in contact with the sidewall S of the tire T before the remaining tire engaging members 140, 160 are placed in initial positions.

The first tire engaging member 120 is positioned at a first azimuth and at a radial distance from the axis A that is selected such that the first tire engaging member 120 is adjacent the bead portion of the tire T.

The second tire engaging member 140 is positioned at a similar radial distance from the axis A and at a second azimuth, approximately 10-50° from the first azimuth. The third tire engaging member 160 is also positioned at a similar radial distance from the axis A and at a third azimuth, approximately 180° from the first azimuth. It should be understood, however, that these positions are merely exemplary, and that initial position of each tire engaging member may be varied. The initial position of each tire engaging member 120, 140, 160 may be selected based on the type of tire being mounted. The size and stiffness of a tire may be factors in determining the optimal initial position of each tire engaging member.

After the tire T, wheel W, and tire mounting device 100 are placed in the initial position, the tire rotating device 100 begins rotating the tire T and wheel W. The tire T and wheel W are rotated at the same speed. However, the tire T may lag behind the rotation of the wheel W. In an alternative embodiment, the tire and wheel may be rotated at different speeds. For discussion purposes, the tire T and wheel W will be described as rotating in a clockwise direction. However, it should be understood that they may be rotated in either direction.

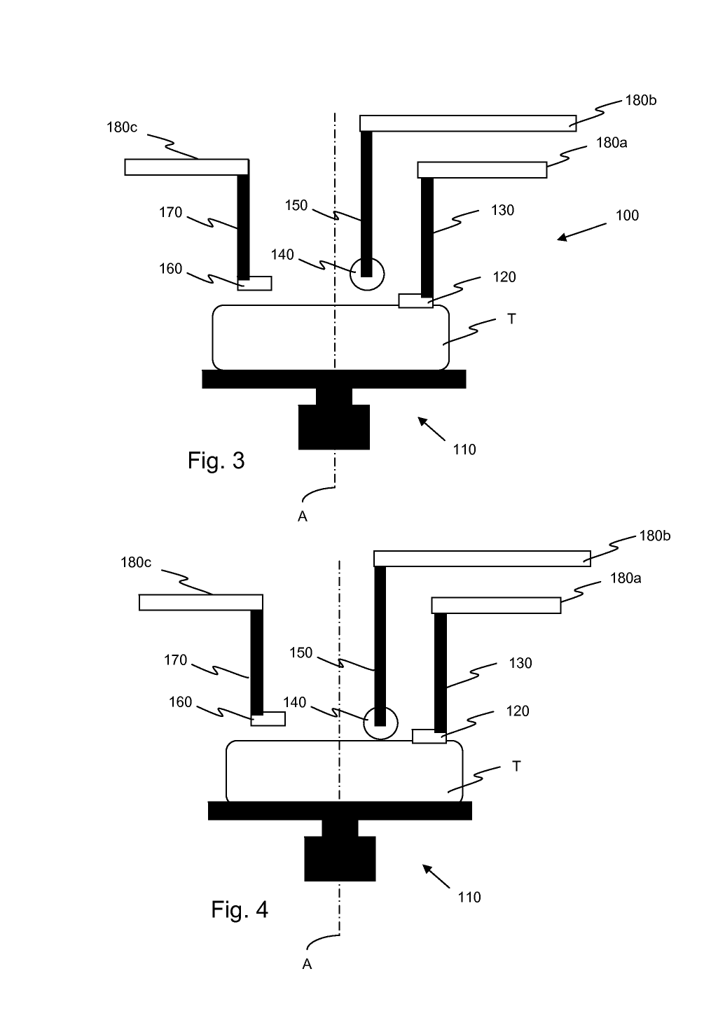

FIG. 3 is a schematic drawing illustrating a side view of the tire mounting device 100 in a second position. In the second position, the first arm 130 moves the first tire engaging member 120 into engagement with the sidewall S of the tire T, thereby pushing a proximal section of a bead of the tire T into a well of the wheel W. The distance that the first arm 130 moves the first tire engaging member 120 will depend on the dimensions of the wheel W and the dimensions and stiffness of the tire T. The first arm 130 may move the first tire engaging member 120 into engagement with the sidewall S before the tire rotating member 110 begins to rotate the tire T and the wheel W. Alternatively, the first arm 130 may move the first tire engaging member 120 into engagement with the sidewall S after the tire rotating member 110 begins to rotate the tire T and the wheel W.

In the illustrated embodiment, the first tire engaging member 120 and first arm 130 do not rotate with respect to the axis A. In an alternative embodiment, the first tire engaging member and first arm rotate about the axis. In one such embodiment, the first tire engaging member and first arm rotate in a clockwise direction. In an alternative embodiment, the first tire engaging member and first arm rotate in a counter-clockwise direction. In such an embodiment, the first tire engaging member and first arm may rotate at the same speed as the tire, or at a different speed as the tire and wheel.

FIG. 4 is a schematic drawing illustrating a side view of the tire mounting device 100 in a third position. In the third position, the second arm 150 moves the second tire engaging member 140 into engagement with the sidewall S of the tire T, thereby pushing a proximal section of a bead of the tire T down and retaining it in the well of the wheel W. In one embodiment, the second tire engaging member 140 moves a proximal section of the bead into the wheel well. It should be understood that the proximal section of the bead is a portion of the bead that is near the tire engaging member. In an alternative embodiment, the proximal section of the bead is already in the wheel well, having been moved into the wheel well by the first tire engaging member 120.

In one embodiment, the distance that the first and second arms 130, 150 extend is programmable. In some instances, it may be desirable for the second arm 150 to extend downward further than the first arm 130, such that the second tire engaging member 140 causes a greater deformation δ of the sidewall than the first tire engaging member 120. In other instances, it may be desirable for the second arm to extend downward by the same distance, or a lesser distance than the first arm. The stiffness of the tire and other characteristics may determine the optimal distance that each arm should move.

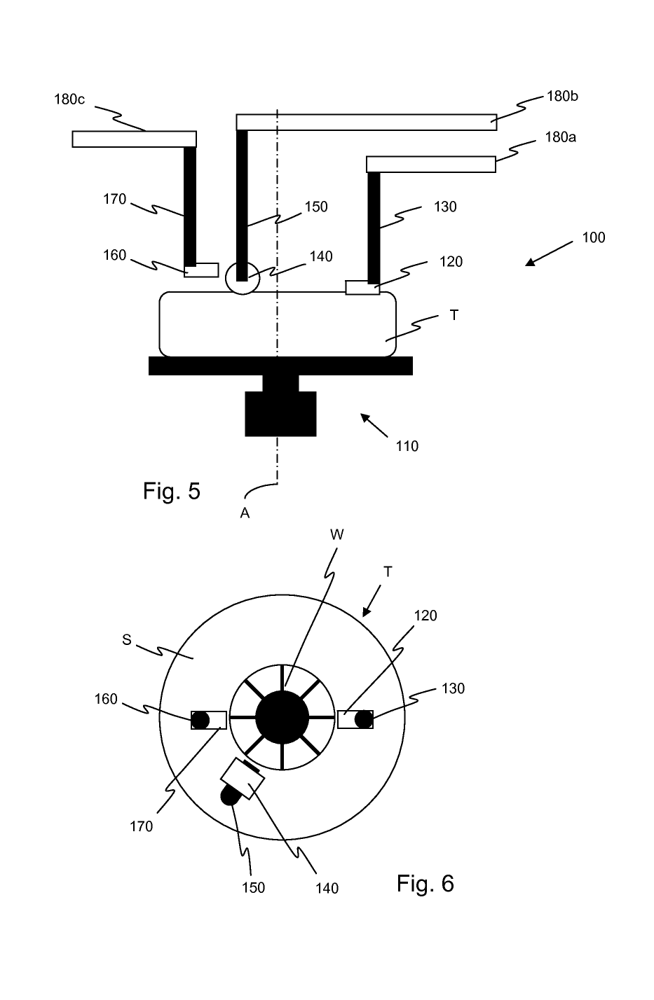

FIGS. 5 and 6 are schematic drawings illustrating side and top views, respectively, of the tire mounting device 100 in a fourth position. In the fourth position, the second arm 150 has been rotated in a clockwise direction until it is adjacent the third arm 170. In the illustrated embodiment, both the tire T and the second arm 150 are rotated in the same direction, with the second arm 150 being rotated at a faster speed than the rotation speed of the tire T. In an alternative embodiment, the second arm is rotated at the same speed or slower than the rotation speed of the tire. In another alternative embodiment, the second arm is rotated in the opposite direction of the rotation of the tire. In yet another alternative embodiment, the second arm is not rotated about the axis of the tire.

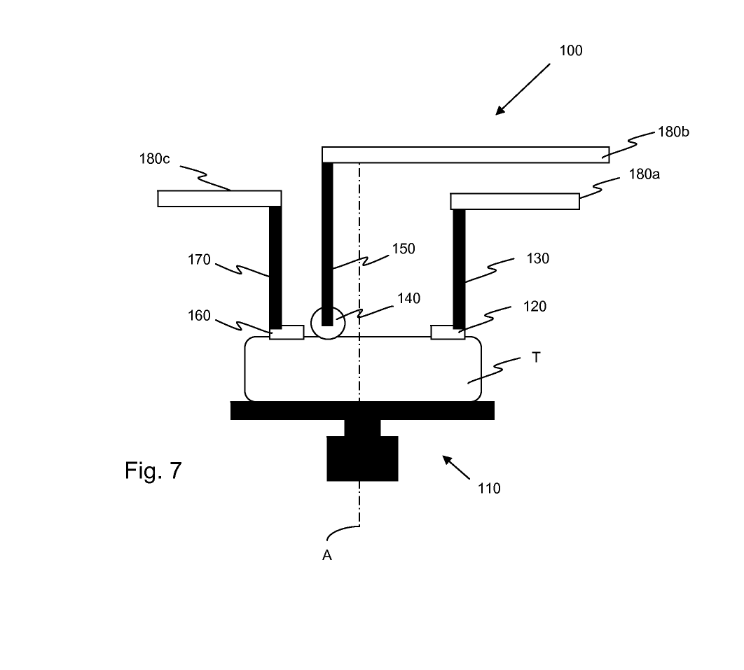

FIG. 7 is a schematic drawing illustrating a side view of the tire mounting device 100 in a fifth position. In the fifth position, the third arm 170 moves the third tire engaging member 160 into engagement with the sidewall S of the tire T, thereby pushing a proximal section of a bead of the tire T. In one embodiment, the proximal section of the bead is already in the wheel well, having been moved into the wheel well by one of the first tire engaging member 120 and second tire engaging member 140. In an alternative embodiment, the third tire engaging member 160 moves the proximal section of the bead into the wheel well.

In one embodiment, the distance that the first, second, and third arms 130, 150, 170 extend is programmable. In some instances, it may be desirable for the third arm 170 to extend downward further than both the first arm 130 and the second arm 150, such that the third tire engaging member 160 causes a greater deformation δ of the sidewall than the first tire engaging member 120 or second tire engaging member 140. In other instances, it may be desirable for the third arm to extend downward by the same distance, or less than one or both of the first arm 130 and second arm 150. The stiffness of the tire and other characteristics may determine the optimal distance that each arm should move.

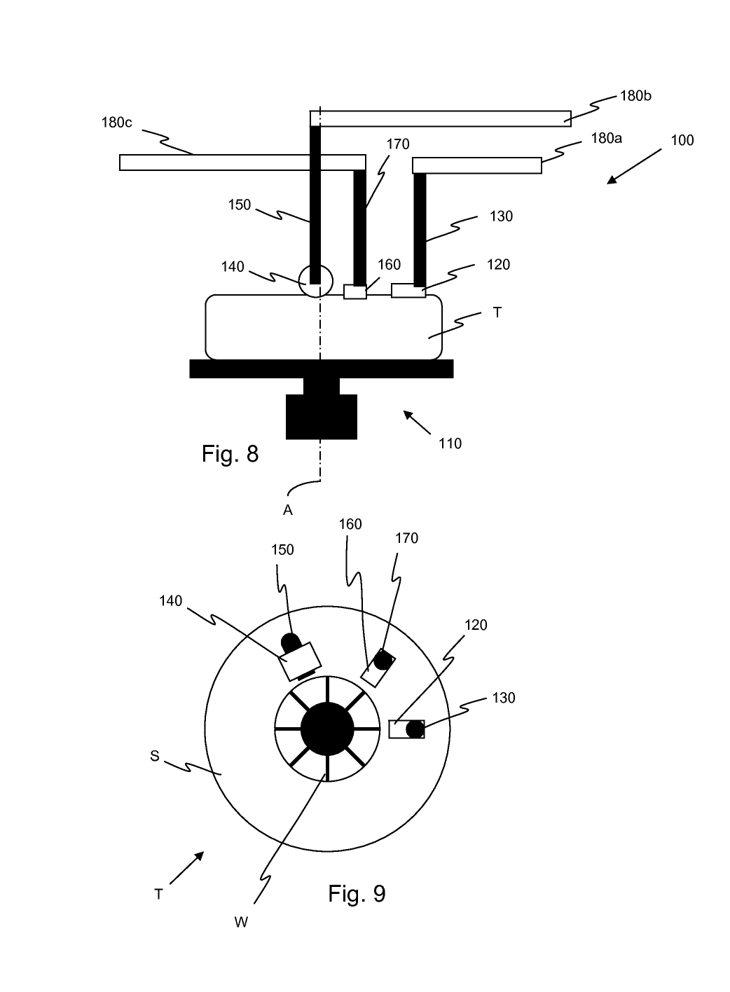

FIGS. 8 and 9 are schematic drawings illustrating side and top views, respectively, of the tire mounting device 100 in a sixth position. In the sixth position, the third arm 170 has been rotated in a clockwise direction until it is adjacent the first arm 110. Additionally, the second arm 150 has been rotated in a clockwise direction such that it remains adjacent the third arm 170.

In the illustrated embodiment, both the tire T, the second arm 150, and the third arm 170 are rotated in the same direction. The second arm 150 is rotated at a faster speed than the rotation speed of the tire T, and the third arm 170 is rotated at a faster speed than both the tire T and the second arm 150. In an alternative embodiment, the third arm is rotated at the same speed or slower than the rotation speed of the tire, the second arm, or both. In one such embodiment, the second arm may move past the third arm during rotation. It should be understood that, in such an embodiment, the second and third arms would have different radial positions to avoid collision. In another alternative embodiment, the second arm and third arm are rotated in the opposite direction of the rotation of the tire. The rotation speed of each arm may be programmable, to allow a user to adjust the speed according to tire stiffness and other characteristics.

In one embodiment, the tire T, second arm 150, and third arm 170 are all rotated at a constant speed. In an alternative embodiment, the rotational speed of one or more of the tire, second arm, and third arm may be varied during rotation of the tire. For example, in one known embodiment, the second arm ceases to rotate after it reaches a predetermined point.

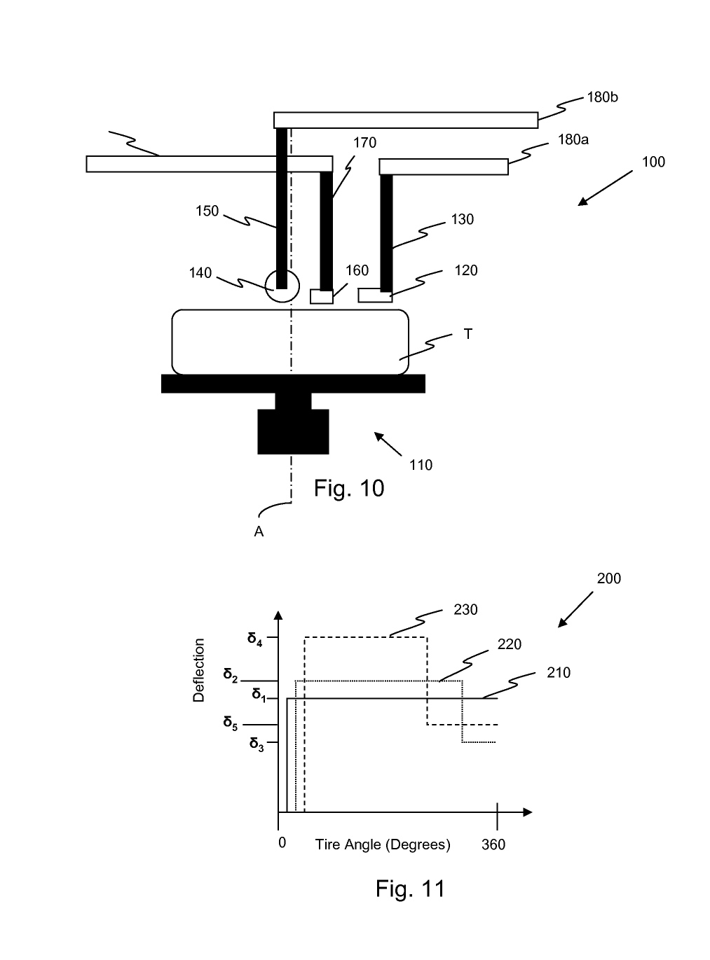

FIG. 10 is a schematic drawing of a side view of the tire mounting device 100 in a final position. In the final position, all of the arms 130, 150, and 170 are raised such that the tire engaging members 120, 140, 160 no longer in contact with the sidewall S of the tire T. When the tire mounting device 100 is in the final position, the bead of the tire T is fully seated in the well of the wheel W.

FIG. 11 is a graph 200 illustrating a deflection of a tire T caused by tire engaging members 120, 140, 160 of the tire mounting device 100 during rotation of the tire T. Line 210 represents the deflection caused by the first tire engaging member 120. Line 220 represents the deflection caused by the second tire engaging member 140. Line 230 represents the deflection caused by the third tire engaging member 160.

As can be seen, in the initial position, none of the tire engaging members 120, 140, 160 cause a deflection in the sidewall S. When the first tire engaging member 120 engages the sidewall S in the second position, it causes a first deflection δ₁ that is then held constant throughout the rotation of the tire T. In one known embodiment, this first deflection δ₁ is 0-20% of the maximum sidewall width of the tire. In other embodiments, this first deflection may range from 0-50% of the maximum sidewall width of the tire. This distance may be programmed by a user, and may be based on the stiffness and other properties of the tire.

When the second tire engaging member 140 engages the sidewall S in the third position, it causes a second deflection δ₂ that greater than the first deflection δ₁ caused by the first tire engaging member. In one known embodiment, this second deflection δ₂ is 10-30% of the maximum sidewall width of the tire. In other embodiments, this second deflection may range from 0-50% of the maximum sidewall width of the tire. This distance may be programmed by a user, and may be based on the stiffness and other properties of the tire.

Just prior to completion of the rotation of the tire T, the second arm 150 is slightly raised, thereby reducing the deflection caused by the second tire engaging member 140, resulting in a third deflection δ₃. This third deflection δ₃ is less than the first deflection δ₁ caused by the first tire engaging member 120. In one known embodiment, this third deflection δ₃ is 0-30% of the maximum sidewall width of the tire. In other embodiments, this second deflection may range from 0-50% of the maximum sidewall width of the tire. This distance may be programmed by a user, and may be based on the stiffness and other properties of the tire.

When the third tire engaging member 160 engages the sidewall S in the fifth position, it causes a fourth deflection δ₄. The fourth deflection δ₄ is greater than both the first deflection δ₁ caused by the first tire engaging member and the second and third deflections δ_{2,3} caused by the second tire engaging member. In one known embodiment, this fourth deflection δ₄ is 20% of the maximum sidewall width of the tire. In other embodiments, this second deflection may range from 0-50% of the maximum sidewall width of the tire. This distance may be programmed by a user, and may be based on the stiffness and other properties of the tire.

Prior to completion of the rotation, the third arm 170 is slightly raised, thereby reducing the deflection caused by the third tire engaging member 140, resulting in a fifth deflection δ₅. The fifth deflection δ₅ is less than the first deflection δ₁ caused by the first tire engaging member 120, but greater than the third deflection δ₃ caused by the second tire engaging member 140. In one known embodiment, this fifth deflection δ₅ is 10% of the maximum sidewall width of the tire. In other embodiments, this second deflection may range from 0-50% of the maximum sidewall width of the tire. This distance may be programmed by a user, and may be based on the stiffness and other properties of the tire.

It should be understood, however, that this graph is merely exemplary. The deflections caused by each of the tire engaging members may be adjusted as desired to efficiently seat the bead in the wheel well.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1-15. (canceled)

16. An apparatus for mounting a tire to a wheel, the apparatus comprising:
a tire rotating device configured to rotate a tire about an axis of rotation;
a plurality of tire engaging members, including at least a first tire engaging member and a second tire engaging member, each tire engaging member being configured to engage a sidewall of the tire;
a plurality of arms, including at least a first arm connected to the first tire engaging member and a second arm connected to the second tire engaging member,
wherein each of the plurality of arms is configured to move a respective connected tire engaging member into engagement with the sidewall of the tire, thereby moving a proximal section of a bead of the tire into a well of the wheel,
wherein each of the plurality of arms is further configured to move the respective connected tire engaging members out of engagement with the sidewall of the tire; and
an arm rotating device configured to rotate the second arm about the axis of rotation.

17. The apparatus of claim 16, wherein the first arm does not rotate about the axis of rotation.

18. The apparatus of claim 16, wherein at least one of the plurality of tire engaging members is a roller.

19. The apparatus of claim 16, wherein at least one of the plurality of tire engaging members is a shoe.

20. The apparatus of claim 16, wherein the tire rotating device rotates the tire at a first rotational speed, and the arm rotating device rotates the second arm about the axis of rotation at a second rotational speed different from the first rotational speed.

21. The apparatus of claim 16, wherein the plurality of tire engaging members further includes a third tire engaging member and the plurality of arms includes a third arm connected to the third tire engaging member, wherein the third arm is configured to move the third tire engaging member into engagement with the sidewall of the tire, thereby moving a proximal section of the bead of the tire into a wheel well of the wheel, and wherein the third arm is further configured to move the third tire engaging members out of engagement with the sidewall of the tire.

22. The apparatus of claim 20, further comprising a second arm rotating device configured to rotate the third arm about the axis of rotation.

23. The apparatus of claim 20, wherein the tire rotating device rotates the tire about the axis of rotation at a first rotational speed, and the second arm rotating device rotates the third arm about the axis of rotation at a second rotational speed different from the first rotational speed.

24. A tire mounting device configured to mount a tire to a wheel having a wheel well, the tire mounting device comprising:
a plurality of tire engaging members including a first tire engaging member, a second tire engaging member, and a third tire engaging member, each of the plurality of tire engaging members being configured to move into and out of engagement with a sidewall of the tire;
a tire rotating device configured to rotate the tire about an axis;
at least one member rotating apparatus configured to rotate the second tire engaging member and the third tire engaging member about the axis.

25. The tire mounting device of claim 24, wherein each of the plurality of tire engaging members is configured to displace the sidewall of the tire such that a proximal section of a bead of the tire is moved into a wheel well.

26. The tire mounting device of claim 24, wherein the at least one member rotating device rotates the second tire engaging member at a first speed, and rotates the third tire engaging member at a second speed different from the first speed.

27. The tire mounting device of claim 26, wherein the tire rotating device rotates the tire at a third speed different from the first speed and different from the second speed.

28. The tire mounting device of claim 24, wherein at least one of the plurality of tire engaging members includes a roller.

29. A method of mounting a tire to a wheel, the method comprising:
providing a wheel;
providing a tire;
rotating the tire about an axis of the tire at a first speed;
moving a first member into engagement with a sidewall of the tire, such that a proximal section of a bead of the tire is placed in a well of the wheel; and
moving a second member into engagement with the sidewall of the tire, such that the section of the bead of the tire is retained in the well of the wheel.

30. The method of claim 29, further comprising moving the second member out of engagement with the sidewall of the tire and moving the first member out of engagement with the sidewall of the tire.

31. The method of claim 29, further comprising rotating the second member about the axis of the tire at a second speed different from the first speed.

32. The method of claim 31, wherein the second member includes a roller, and wherein the second member is rotated about the axis of the tire such that the roller rolls over the sidewall of the tire.

33. The method of claim 31, further comprising moving a third member into engagement with a sidewall of the tire, such that the section of the bead of the tire is retained in the well of the wheel.

34. The method of claim 33, further comprising rotating the third member about the axis of the tire at a third speed different from the first speed and different from the second speed.

35. The method of claim 33, further comprising moving the third member out of engagement with the sidewall.
